(19) United States
(12) Patent Application Publication
(10) Pub. No.: US 2021/0274727 A1
(43) Pub. Date: Sep. 9, 2021

(54) STRAW-BASED POT BODY BLANKET SEEDLING GROWTH SUBSTRATE AND PREPARATION METHOD THEREFOR

(71) Applicant: Jiangsu Academy of Agricultural Sciences, Jiangsu (CN)

(72) Inventors: Ping QU, Jiangsu (CN); Hongying HUANG, Jiangsu (CN); Enhui SUN, Jiangsu (CN); Yun CAO, Jiangsu (CN); Huashan WU, Jiangsu (CN); Yueding XU, Jiangsu (CN)

(21) Appl. No.: 16/619,545

(22) PCT Filed: Nov. 7, 2018
(86) PCT No.: PCT/CN2018/114407

§ 371 Date: Dec. 5, 2019

(30) Foreign Application Priority Data
May 29, 2018 (CN) 201810533934.X

(51) Int. Cl. A01G 24/15; A01G 24/22; A01G 24/44; A01G 24/30; A01G 24/60

(52) U.S. Cl. CPC A01G 24/15; A01G 24/22; A01G 24/60; A01G 24/30; A01G 24/44

(57) ABSTRACT

A straw-based pot body blanket seedling growth substrate using straw fibres as a framework, utilising an enhancer, a retention aid and a wet strength agent as additives, and being prepared from composite decomposed livestock manure, perlite and vermiculite, the addition amount of the straw fibres being 60-70 v/v %, the addition amount of the decomposed livestock manure being 5-10 v/v %, the addition amount of the perlite being 5-10 v/v %, the addition amount of the vermiculite being 5-10 v/v %. The pot body blanket seedling growth substrate is suitable for cutting and easily implementing fully automated transplantation, is beneficial for root growth, shortens seeding growth periods, and increases seedling growth bed emergence rates. The pot body blanket seedling growth substrate may be applied to solanaceae seedling growth, and can also provide a block-shaped substrate for landscape flowers and plants in a three-dimensional arrangements.

### I. CROSS-REFERENCE TO RELATED APPLICATIONS

The present application is a national stage entry of international application PCT/CN2018/114407, filed Nov. 7, 2018, which claims priority to CN Patent application number 201810533934.X, filed May 29, 2018, the content of which is incorporated herein by reference in its entirety.

### II. TECHNICAL FIELD

The present invention relates to the technical field of seedling cultivation of rice, solanaceous vegetables, rape, etc., and specifically relates to a straw-based pot body blanket seedling cultivation substrate.

### III. BACKGROUND

As a large agricultural country, China can generate more than 700 million tons of straws each year. A large number of straws are burned in the fields every year, which causes serious pollution to the environment. Therefore, it is necessary to develop and utilize crop straws. The crop straws are mainly composed of cellulose, hemicellulose, lignin and a small amount of crude protein, crude fat, silicate and a small amount of other trace elements, and are a kind of renewable biomass resource for development and utilization. Straw is rich in natural cellulose fiber and is a good raw material for papermaking. By utilizing the hydrogen bond between the cellulose in the straws and enhancers, products such as biodegradable pot body blanket seedling cultivation plates that have certain water resistance and strength can be made. Thus, the problems such as long path and low efficiency (50-100 plants/min) in the seedling picking process for pot seedling transplantation and high requirement on the age of seedlings (15-21 days) are solved. Blanket seedlings are torn from the blanket by planting arm rotation and inserted into a paddy field, causing damage to seedlings. After transplantation, a rejuvenation period is required, which may affect the yield, but the transplantation efficiency is high, i.e. 100-200 plants/min. In contrast, for the straw-based pot body blanket seedling planting technique, the field planting of seedling is transplanted with the pots, with low rate of damage to seedlings and roots, and there is basically no rejuvenation period after planting, therefore, it is conducive to achieve high yield. The pot body is biodegradable, after returning to the field, it can supplement and balance nutrients in the soil, increase soil organic matter content, increase soil fertility, and improve soil aggregate structure, thereby reducing fertilizer use and increasing the yield.

### IV. SUMMARY

It is an object of the present invention to provide a straw-based pot body blanket seedling cultivation substrate, to solve the problems of poor quality and low efficiency of transplanting in the solanaceae in the prior art.

To attain the object described above, the present invention provides the following technical solutions:

A straw-based pot body blanket seedling cultivation substrate, using straw fiber as a framework, utilizing an enhancer, a retention agent and a wet strength agent as additives, and being prepared by combining with decomposed livestock manure, perlite and vermiculite. It can improve the root twining of solanaceae seedlings while improving the efficiency of transplantation.

The straw-based pot body blanket seedling cultivation substrate in the present invention, wherein, the addition amount of the straw fibers being 60-70 v/v %; the addition amount of the decomposed livestock manure being 5-10 v/v %; the addition amount of the perlite being 5-10 v/v %; and the addition amount of the vermiculite being 5-10 v/v %.

The straw-based pot body blanket seedling cultivation substrate of the present invention, wherein the enhancer is an alkyl ketene dimer neutral sizing agent, and the addition amount accounts for 0.1-2.5% of the mass of the straw fibers.

The straw-based pot body blanket seedling cultivation substrate of the present invention, wherein the retention agent is cationic polyacrylamide, and the addition amount accounts for 0.1-1.0% of the mass of the straw fibers.

The straw-based pot body blanket seedling cultivation substrate of the present invention, wherein the wet strength agent is a polyamide epoxy resin, and the addition amount accounts for 0.5-5.5% of the mass of the straw fibers. By adjusting the addition amount of the enhancer, retention agent and wet strength agent, the toughness, water retention and entwining property of the pot body blanket seedling cultivation substrate is adjusted to prepare a pot body blanket seedling cultivation substrate with moderate tensile strength to facilitate cutting, enhance the transplanting efficiency and reduce labors.

The straw-based pot body blanket seedling cultivation substrate of the present invention, wherein the straw fibers are rice or wheat straw fibers.

In the straw-based pot body blanket seedling cultivation substrate of the present invention, wherein the pot body substrate block of the straw-based pot body blanket seedling cultivation substrate is in a block shape, with an upper diameter of 1.0 cm and a lower diameter of 0.5 cm and a depth of 0.5 cm-1.0 cm, in an inverted cone shape; the spacing of the pot body substrate blocks is 0.3 cm-0.5 cm, and reinforcement ribs are provided between the pot body substrate blocks, with a thickness of 0.2 cm-0.3 cm, which can effectively prevent collapse of the pot body at the cutting place caused by too much moisture during the seedling cultivation period.

The straw-based pot body blanket seedling cultivation substrate of the present invention, wherein the thickness of the blanket portion of the straw-based pot body blanket seedling cultivation substrate is 2.0 cm-3.0 cm.

A method for preparing a straw-based pot body blanket seedling cultivation substrate of the present invention, including the following steps: controlling the depth of the pot body by enhancers using a vacuum adsorption molding die; preparing a pot body blanket seedling cultivation substrate by adjusting the addition amount of the straw fibers, the thickness of the blanket portion and the addition amount of various components in the substrate.

An application of the straw-based pot body blanket seedling cultivation substrate of the present invention, wherein the daily watering amount is 10-100 mL/seedling according to the characteristics of the tap root system of the solanaceae, and the tidal irrigation method is used to make the bottom moist and facilitate the growth of the root system; the upper adhesion part is dry, with little or no root growth.

Compared with the prior art, the present invention attains the following beneficial effects:
(1) The pot body blanket seedling cultivation substrate is suitable for cutting and easily implementing fully automated transplantation, is also beneficial for the formation of root twine, shortens seedling cultivation periods, and increases emergence rate of seedling bed. The pot body blanket seedling cultivation substrate may not only be applied to the seedling cultivation of solanaceae, but can also provide a block-shaped substrate for landscape flowers and plants in a three-dimensional arrangement.
(2) For the pot body blanket seedling planting technique of the present invention, the seedling roots have more soil, with low damage rate to seedlings and roots, and the rejuvenation period after planting is short, which is beneficial to achieve high yield.

### V. BRIEF DESCRIPTION OF THE DRAWINGS

FIG. 1 is a top view and a front view of the pot body blanket seedling cultivation substrate of the present invention;

FIG. 2 is a perspective view of the pot body blanket seedling cultivation substrate of the present invention.

### VI. DETAILED DESCRIPTION

The technical solutions in the embodiments of the present invention are explicitly and completely described in the following with reference to the accompanying drawings. Apparently, the embodiments described herein are only a part but not all of embodiments of the present invention. All other embodiments obtained by those skilled in the art based on the embodiments of the present invention without creative work are within the protection scope of the present invention.

A straw-based pot body blanket seedling cultivation substrate, using straw fiber as a framework, utilizing an enhancer, a retention agent and a wet strength agent as additives, and being prepared by combining with decomposed livestock manure, perlite and vermiculite. Wherein, straw fibers are rice or wheat straw fibers. The addition amount of the straw fibers is 60-70 v/v %; the addition amount of the decomposed livestock manure is 5-10 v/v %; the addition amount of the perlite is 5-10 v/v %; and the addition amount of the vermiculite is 5-10 v/v %. It can improve the root twining of solanaceae seedlings while improving the efficiency of transplantation.

Wherein, the enhancer is alkyl ketene dimer neutral sizing agent (AKD), and the addition amount accounts for 0.1-2.5% of the mass of the straw fibers. The retention agent is cationic polyacrylamide (CPAM), and the addition amount accounts for 0.1-1% of the mass of the straw fibers. The wet strength agent is a polyamide epoxy resin (PAE), and the addition amount accounts for 0.5-5.5% of the mass of the straw fibers.

By adjusting the addition amount of the enhancer, retention agent and wet strength agent, the toughness, water retention and entwining property of the pot body blanket seedling is adjusted to prepare a pot body blanket seedling cultivation substrate with moderate tensile strength to facilitate cutting, enhance the transplanting efficiency and reduce labors.

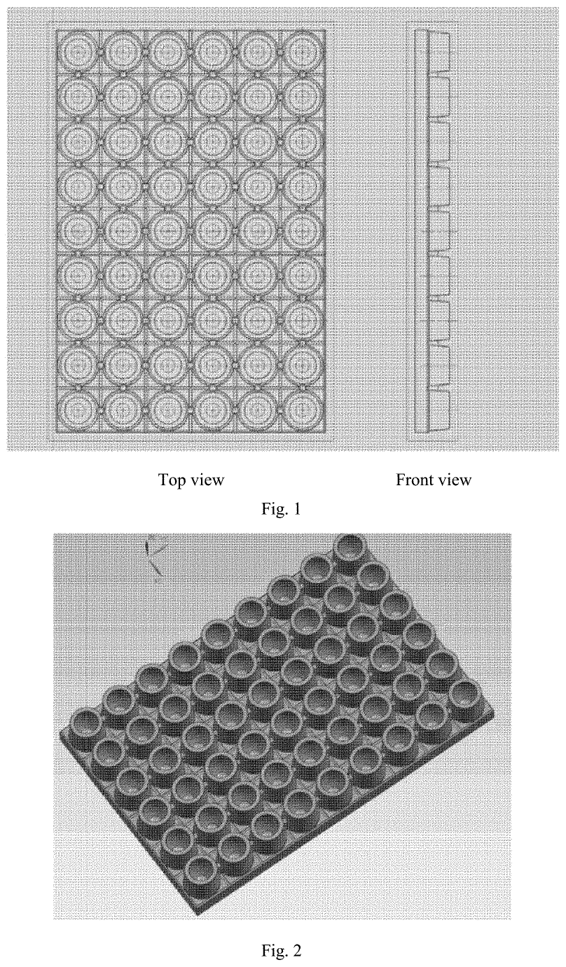

As shown in FIGS. 1-2, the pot body substrate block of the straw-based pot body blanket seedling cultivation substrate is in a block shape, with an upper diameter of 1.0 cm and a lower diameter of 0.5 cm and a depth of 0.5 cm-1.0 cm, in an inverted cone shape; the spacing of the pot body substrate blocks is 0.3 cm-0.5 cm, and reinforcement ribs are provided between the pot body substrate blocks, with a thickness of 0.2 cm-0.3 cm, which can effectively prevent collapse of the pot body at the cutting place caused by too much moisture during the seedling cultivation period. The thickness of the blanket portion of the straw-based pot body blanket seedling cultivation substrate is 2.0 cm-3.0 cm.

A preparation method of straw-based pot body blanket seedling cultivation substrate includes the following steps:

Controlling the depth of the pot body by enhancers using a vacuum adsorption molding die; preparing a pot body blanket seedling cultivation substrate by adjusting the addition amount of the straw fibers, the thickness of the blanket portion and the addition amount of various components in the substrate.

According to the characteristics of the tap root system of the solanaceae, i.e. the main root and the lateral root are distinctly defined, and the main root is strongly inserted into the soil. As the depth increases, the root length density of the intact root decreases rapidly. The growth of root system is controlled by water. The daily watering amount is 10-100 mL/seedling. The tidal irrigation method is used to make the bottom moist and facilitate the growth of the root system; the upper adhesion part is dry, with little or no root growth, reducing damage to the root system while transplanting and cutting.

After sowing the prepared pot body blanket seedlings, the effects of different formulas on the morphological indexes of the seedlings, including the germination, seedling plant height, stem diameter, fresh weight, dry weight, leaf area, root-shoot ratio and other growth indicators, and the entwining property of the blanket seedlings after seedling formation, i.e. the tensile strength, integrity, etc. are determined.

Table 1 exemplifies the ratio of components of 4 types of straw-based pot body blanket seedling cultivation substrates prepared by the preparation method of the present invention, and Table 2 shows the comparisons of basic properties between the 4 types of straw-based pot body blanket seedling cultivation substrates and the whole substrate.

TABLE 1
Ratio of components of four types of straw-based
pot body blanket seedling cultivation substrates

| | | Decomposed | | | | | |
|---|---|---|---|---|---|---|---|
| | Straw | livestock | | | | | |
| | fibers | manure | Perlite | Vermiculite | Addition amount (%) | | |
| No. | (v/v %) | (v/v %) | (v/v %) | (v/v %) | AKD | CPAM | PAE |
| Whole substrate | 70 | 10 | 10 | 10 | 0 | 0 | 0 |
| (comparison) | | | | | | | |
| I-blanket | 70 | 10 | 10 | 10 | 2 | 2 | 2 |
| substrate | | | | | | | |
| II- blanket | 70 | 10 | 10 | 10 | 1 | 1 | 2 |
| substrate | | | | | | | |
| III- blanket | 65 | 15 | 10 | 10 | 1 | 2 | 1 |
| substrate | | | | | | | |
| IV- blanket | 60 | 20 | 10 | 10 | 3 | 2 | 3 |
| substrate | | | | | | | |

TABLE 2
Basic properties of blanket seedling cultivation substrate

| | | Water- | | Tensile |
|---|---|---|---|---|
| | Aeration | holding | Total | strength |
| | porosity % | porosity % | porosity % | Mpa |
| Whole substrate | 18.2 | 54.7 | 72.9 | 0.05 |
| (comparison) | | | | |
| I-blanket substrate | 16.6 | 49.2 | 65.8 | 0.35 |
| II- blanket substrate | 17.2 | 47.6 | 64.8 | 0.25 |
| III- blanket substrate | 17.2 | 51.2 | 68.4 | 0.2 |
| IV- blanket substrate | 18.1 | 44.5 | 62.6 | 0.15 |

Taking tomato seedlings as an example, the effects of different substrates on the morphological indexes of seedlings are determined by using the whole substrate and the 4 types of blanket substrates in Table 2, results are shown in Table 3.

TABLE 3
Growth indexes of tomato seedlings

| | Seedling | Stem | Root | Leaf | | Fresh weight | | Dry weight | |
|---|---|---|---|---|---|---|---|---|---|
| | height | diameter | length | area | Chlorophyll | (g) | | (g) | |
| Sample | (mm) | (mm) | (mm) | (cm²) | (CCI) | Shoot | Root | Shoot | Root |
| Whole substrate | 94.39 | 2.11 | 89.70 | 34.07 | 9.67 | 0.74 | 0.61 | 0.10 | 0.08 |
| (comparison) | | | | | | | | | |
| I-blanket | 120.53 | 2.29 | 90.45 | 50.19 | 11.63 | 1.39 | 0.89 | 0.12 | 0.09 |
| substrate | | | | | | | | | |
| II- blanket | 113.77 | 2.11 | 88.55 | 62.45 | 13.07 | 1.29 | 1.01 | 0.19 | 0.15 |
| substrate | | | | | | | | | |
| III- blanket | 133.56 | 3.11 | 89.91 | 65.40 | 15.66 | 1.44 | 1.25 | 0.30 | 0.17 |
| substrate | | | | | | | | | |
| IV- blanket | 129.23 | 2.48 | 84.76 | 63.22 | 14.98 | 1.21 | 1.10 | 0.35 | 0.15 |
| substrate | | | | | | | | | |

A transplanting test is carried out by using a modified transplanter. Taking tomato as an example, the dryland transplanting test data is shown in Table 4.

TABLE 4
Dryland transplanting test of tomato

| | | Reveal | Replanting | Lodging | Seedling | Seedling | Injury rate | Pass |
|---|---|---|---|---|---|---|---|---|
| | | rate | rate | rate | bury rate | rate | of seedling | rate |
| Sample | | (%) | (%) | (%) | (%) | (%) | (%) | (%) |
| Whole | a | 2.56 | 1.54 | 4.14 | 2.05 | 2.56 | 3.62 | 83.54 |
| substrate | b | 2.03 | 2.03 | 3.58 | 1.02 | 2.03 | 4.08 | 85.23 |
| (comparison) | | | | | | | | |
| I-blanket | | | | | | | | |
| substrate | | | | | | | | |
| II- blanket | a | 0.38 | 1.87 | 0.76 | 1.87 | 1.13 | 1.88 | 92.12 |
| substrate | b | 1.93 | 1.16 | 1.56 | 0.77 | 1.16 | 1.17 | 92.26 |
| III- blanket | | | | | | | | |
| substrate | | | | | | | | |
| IV- blanket | a | 1.47 | 1.47 | 1.48 | 1.10 | 0.73 | 1.47 | 92.29 |
| substrate | | | | | | | | |
| Whole | b | 1.14 | 1.14 | 0.77 | 1.14 | 0.76 | 1.53 | 93.52 |
| substrate | | | | | | | | |
| (comparison) | | | | | | | | |
| I-blanket | a | 0.44 | 0.88 | 1.33 | 0.44 | 0.88 | 1.77 | 94.27 |
| substrate | b | 1.31 | 1.31 | 0.88 | 0.87 | 0.43 | 0.88 | 94.33 |
| II- blanket | | | | | | | | |
| substrate | | | | | | | | |
| III- blanket | a | 0.89 | 0.89 | 0.90 | 0.45 | 0.89 | 1.80 | 94.18 |
| substrate | b | 0.44 | 1.31 | 1.32 | 0.87 | 1.30 | 2.18 | 92.58 |

a, b: parallel treatment

While the present invention has been illustrated and described with reference to some embodiments, the present invention is not limited to those embodiments. Those skilled in the art should recognize that various variations, modifications, substitutions and variants can be made to those embodiments without departing from the spirit and scope of the present invention as defined by the accompanying claims and their equivalents.

1. A straw-based pot body blanket seedling cultivation substrate, wherein, the substrate uses straw fibers as a framework, utilizes an enhancer, a retention agent and a wet strength agent as additives, and is prepared by combining with decomposed livestock manure, perlite and vermiculite.

2. The straw-based pot body blanket seedling cultivation substrate according to claim 1, wherein the addition amount of the straw fibers is 60-70 v/v %; the addition amount of the decomposed livestock manure is 5-10 v/v %; the addition amount of the perlite is 5-10 v/v %; and the addition amount of the vermiculite is 5-10 v/v %.

3. The straw-based pot body blanket seedling cultivation substrate according to claim 2, wherein the enhancer is an alkyl ketene dimer neutral sizing agent, and the addition amount accounts for 0.1-2.5% of the mass of the straw fibers.

4. The straw-based pot body blanket seedling cultivation substrate according to claim 3, wherein the retention agent is cationic polyacrylamide, and the addition amount accounts for 0.1-1.0% of the mass of the straw fibers.

5. The straw-based pot body blanket seedling cultivation substrate according to claim 4, wherein the wet strength agent is a polyamide epoxy resin, and the addition amount accounts for 0.5-5.5% of the mass of the straw fibers.

6. The straw-based pot body blanket seedling cultivation substrate according to claim 5, wherein the straw fibers are rice or wheat straw fibers.

7. The straw-based pot body blanket seedling cultivation substrate according to claim 6, wherein the pot body substrate block of the straw-based pot body blanket seedling cultivation substrate is in a block shape, with an upper diameter of 1.0 cm and a lower diameter of 0.2 cm-0.5 cm and a depth of 0.5 cm-1.0 cm, in an inverted cone shape; the spacing of the pot body substrate blocks is 0.3 cm-0.5 cm; and reinforcement ribs are provided between the pot body substrate blocks, with a thickness of 0.2 cm-0.3 cm.

8. The straw-based pot body blanket seedling cultivation substrate according to claim 7, wherein the thickness of the blanket portion of the straw-based pot body blanket seeding cultivation substrate is 2.0 cm-3.0 cm.

9. A method for preparing the straw-based pot body blanket seedling cultivation substrate according to claim 1, comprising the following steps: controlling the depth of the pot body by enhancers using a vacuum adsorption molding die; preparing a pot body blanket seedling cultivation substrate by adjusting the addition amount of the straw fibers, the thickness of the blanket portion and the addition amount of various components in the substrate.

10. An application of the straw-based pot body blanket seedling cultivation substrate according to claim 1, wherein the daily watering amount is 10-100 mL/seedling according to the characteristics of the tap root system of the solanaceae, and the tidal irrigation method is used to make the bottom moist and facilitate the growth of the root system; the upper adhesion part is dry, with little or no root growth.
